(19) United States
(12) Patent Application Publication
(10) Pub. No.: US 2015/0340175 A1
(43) Pub. Date: Nov. 26, 2015

(54) KEY

(71) Applicant: Chicony Electronics Co., Ltd., New Taipei City (TW)

(72) Inventors: CHENG-FU TSENG, New Taipei City (TW); CHIEH-FAN CHUANG, New Taipei City (TW); LIANG-CHUN YEH, New Taipei City (TW)

(21) Appl. No.: 14/475,943

(22) Filed: Sep. 3, 2014

(30) Foreign Application Priority Data
May 21, 2014 (TW) 103208866

(51) Int. Cl. H01H 13/7065; H01H 13/20

(52) U.S. Cl. CPC H01H 13/7065; H01H 13/20

(57) ABSTRACT

A key is provided. The key includes a substrate, a keycap member, a first balance rod and a second balance rod. The keycap member is movably disposed on the substrate and includes two short lateral sides and two long lateral sides. The first balance rod is disposed between the keycap member and the substrate. An extended direction of the first balance rod is parallel to profile lines of the long lateral sides, and the first balance rod is connected to one of the two long lateral sides and the substrate. The second balance rod is disposed between the keycap member and the substrate. An extended direction of the second balance rod is parallel to profile lines of the short lateral sides, and the second balance rod is connected to the short lateral sides and the substrate.

### CROSS-REFERENCES TO RELATED APPLICATIONS

This non-provisional application claims priority under 35 U.S.C. §119(a) on Patent Application No. 103208866 filed in Taiwan, R.O.C. on 2014 May 21, the entire contents of which are hereby incorporated by reference.

### BACKGROUND

1. Technical Field

The disclosure relates to a key, and particularly to a key is using in a keyboard.

2. Related Art

A keyboard is a common device for inputting data, and usually used along with electronic devices such as a laptop PC, a notebook PC, a smartphone or a tablet PC. However, with the evolution of related technologies, the thicknesses of electronic device and keyboard have been gradually and continuously reduced, resulting in some issues to be overcome, as described in the following paragraphs.

The conventional keyboard substantially includes a substrate, a plurality of keys and a plurality of rubber domes, wherein the substrate includes a circuit board assembled thereon, the keys are movably assembled on the circuit board, and each rubber dome is connected between the circuit board and each corresponding key. Upon operation, a user presses the key downwardly so that the corresponding rubber dome contacts with the contact of the circuit board to generate a signal for text inputting. Conventionally, the thickness and the weight of the keyboard are reduced by reducing the distance between each of the keys and the substrate. Nevertheless, upon operation, the user sometimes can hardly press the center part of the key; that is, when the user presses the edge of the key, the key, especially if it is an elongated shaped key, can be possibly partially deformed (specifically, the edge of the pressed key can be possibly bent downwardly) or tilted toward the edge of the key being pressed, such that the edge of the key contacts with the substrate firstly (once the distance between the key and the substrate is reduced, the edge of the key contacts with the substrate faster and earlier), and the key cannot move downward in an uniform manner. As a result, the key can hardly press against the rubber dome to allow the rubber dome to touch the contact of the circuit board, and no signals are generated. Therefore, improving the structure of the conventional keyboard is an urgent matter for person skilled in the art to address.

### SUMMARY

In view of this, the disclosure provides a key including a substrate, a keycap member, a first balance rod and a second balance rod. The keycap member is movably disposed on the substrate and includes two short lateral sides and two long lateral sides. The first balance rod is disposed between the keycap member and the substrate. An extended direction of the first balance rod is parallel to profile lines of the long lateral sides, and the first balance rod is connected to one of the two long lateral sides and the substrate. The second balance rod is disposed between the keycap member and the substrate. An extended direction of the second balance rod is parallel to profile lines of the short lateral sides, and the second balance rod is connected to the short lateral sides and the substrate.

In some implementation aspects, the second balance rod includes a second shaft, two second lateral rods and two second connecting portions. The two second lateral rods are respectively connected to two ends of the second shaft, and each of the second connecting portions is respectively disposed at end portions of the second lateral rods. The second shaft is connected to the short lateral sides, and the second connecting portions are connected to the substrate. The first balance rod includes a first shaft, two first lateral rods and two first connecting portions. The two first lateral rods are respectively connected to two ends of the first shaft, and each of the first connecting portions is respectively disposed at end portion of the first lateral rods. Embodiments are not limited thereto; the first balance rod and the second balance rod can be formed as a frame.

In some implementation aspects, a distance between the second shaft and the profile line of the short lateral side adjacent to the second shaft is smaller than 15 mm, but embodiments are not limited thereto; the distance can be smaller than 10 mm or 5 mm in some implementation aspects.

As above, the keycap member includes the first balance rods assembled on the long lateral sides thereof, and includes the second balance rods assembled on the short lateral sides thereof. Additionally, the extended direction of the first balance rod is parallel to the profile lines of the long lateral sides, and the extended direction of the second balance rod is parallel to the profile lines of the short lateral sides. Consequently, even when the edge or the corner of the keycap member is pressed, the force applied is delivered simultaneously along the extended directions of the long lateral side and short lateral side of the keycap member, to all parts of the keycap member through the first balance rod and the second balance rod, so that the keycap member can move downward uniformly to generate a signal.

The disclosure further provides a keyboard including a substrate and a key assembly. The key assembly includes a plurality of normal keys and at least one of the aforementioned key. The normal keys and the key are movably disposed on the substrate, respectively.

The detailed features and advantages of the disclosure are described below in great detail through the following embodiments, the content of which is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only, and thus not limitative of the disclosure, wherein:

FIG. 1 is an exploded view of a key of a first embodiment of the disclosure;

FIG. 2 is another exploded view of the key of the first embodiment of the disclosure;

FIG. 3 is a top view of the key of the first embodiment of the disclosure;

FIG. 4 is a lateral view of the key of the first embodiment of the disclosure;

FIG. 5 is another lateral view of the key of the first embodiment of the disclosure;

FIG. 6 is an operational view for showing the key is pressed;

FIG. 7 is a top view of a key of a second embodiment of the disclosure;

FIG. 8 is a top view of a key of a third embodiment of the disclosure;

FIG. 9 is a top view of a key of a fourth embodiment of the disclosure;

FIG. 10 is an enlarged perspective view of a fifth embodiment of the disclosure; and

FIG. 11 is a perspective view of a keyboard of one embodiment of the disclosure.

### DETAILED DESCRIPTION

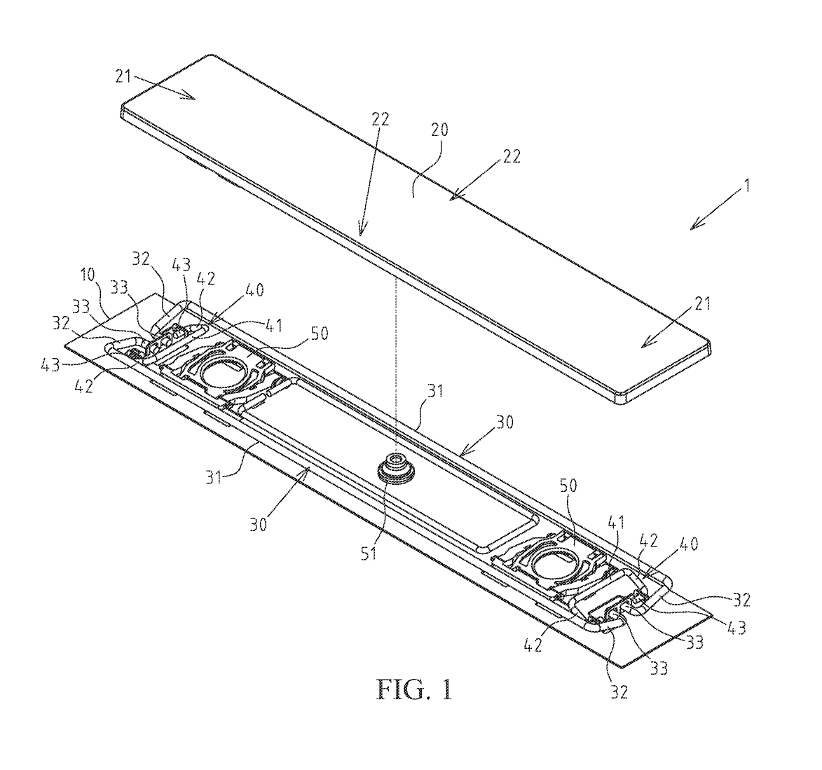

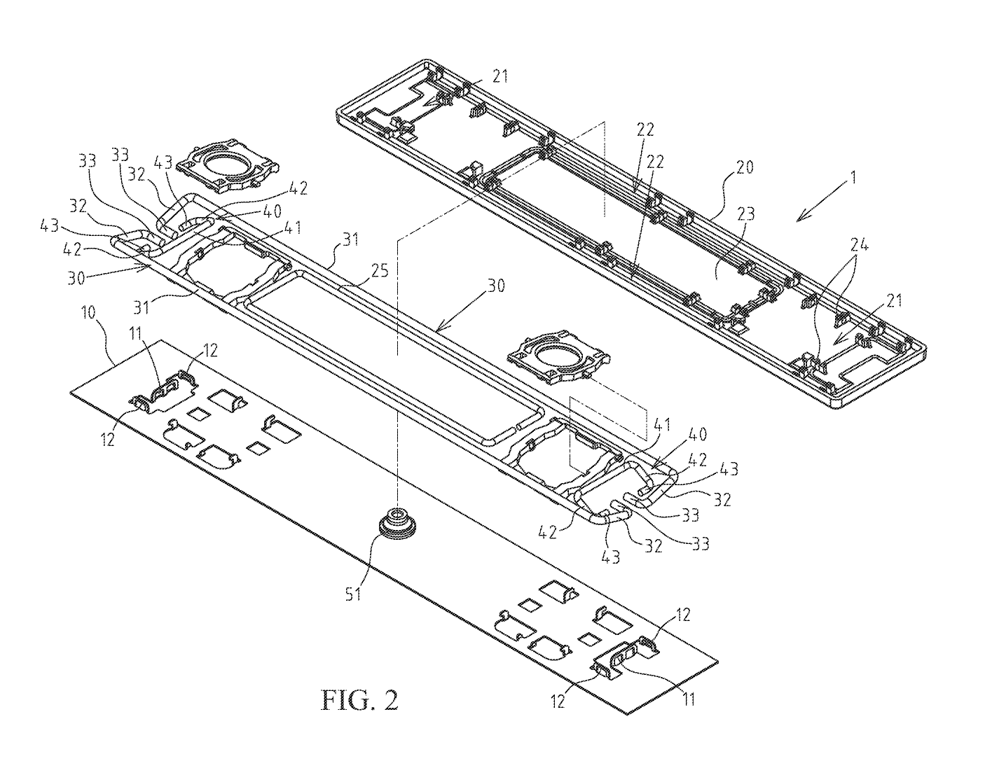

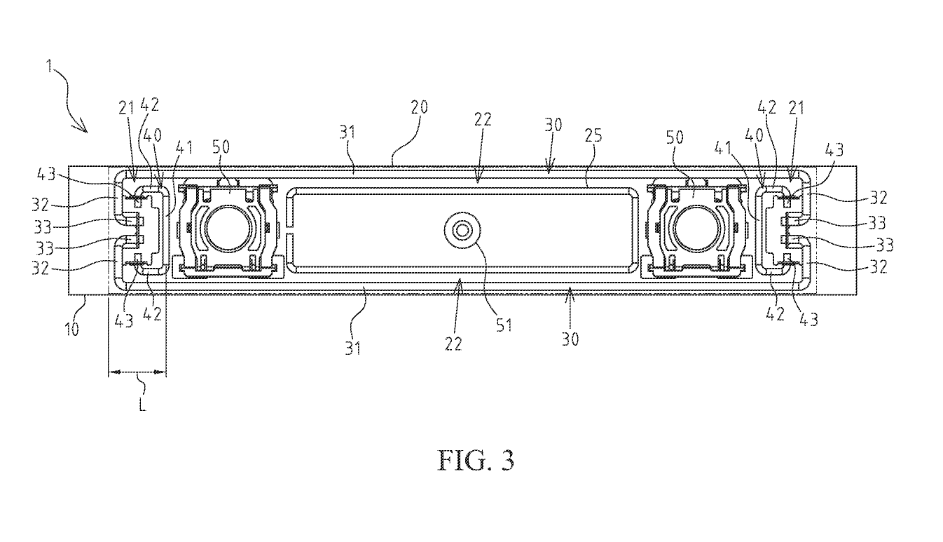

Please refer to FIG. 1, FIG. 2 and FIG. 3, in which a key 1 is illustrated. In this embodiment, the key 1 includes a substrate 10, a keycap member 20, two first balance rods 30 and two second balance rods 40. The keycap member 20 is movably disposed on the substrate 10, and the keycap member 20 includes two short lateral sides 21 and two long lateral sides 22. The first balance rod 30 is disposed between the keycap member 20 and the substrate 10. An extended direction of the first balance rod 30 is substantially parallel to profile lines of the long lateral sides 22, and the two first balance rods 30 are respectively connected to the two long lateral sides 22 and the substrate 10. Preferably, the two first balance rods 30 are disposed at a bottom of the keycap member 20 symmetrically, so that upon the user pressing the long lateral sides 22 of the keycap member 20, the force applied by the user is delivered through the first balance rods 30, and the keycap member 20 can be moved downwardly in a uniform manner upon being pressed. The second balance rod 40 is disposed between the keycap member 20 and the substrate 10, and an extended direction of the second balance rod 40 is parallel to profile lines of the short lateral sides 21. Each second balance rod 40 is connected to each corresponding short lateral side 21 and the substrate 10.

The first balance rod 30 includes a first shaft 31, two first lateral rods 32 and two first connecting portions 33. The first lateral rods 32 are respectively connected to two ends of the first shaft 31, and the first connecting portions 33 are respectively disposed at end portions of the first lateral rods 32. In this embodiment, the key 1 includes two first balance rods 30, the first shaft 31 of each first balance rod 30 is connected to each corresponding long lateral side 22, and the first connecting portions 33 are connected to the substrate 10. The second balance rod 40 includes a second shaft 41, two second lateral rods 42 and two second connecting portions 43. The second lateral rods 42 are respectively connected to two ends of the second shaft 41, and the second connecting portions 43 are respectively disposed at end portions of the second lateral rods 42. The second shaft 41 is connected to the short lateral sides 21, and the second connecting portions 43 are connected to the substrate 10.

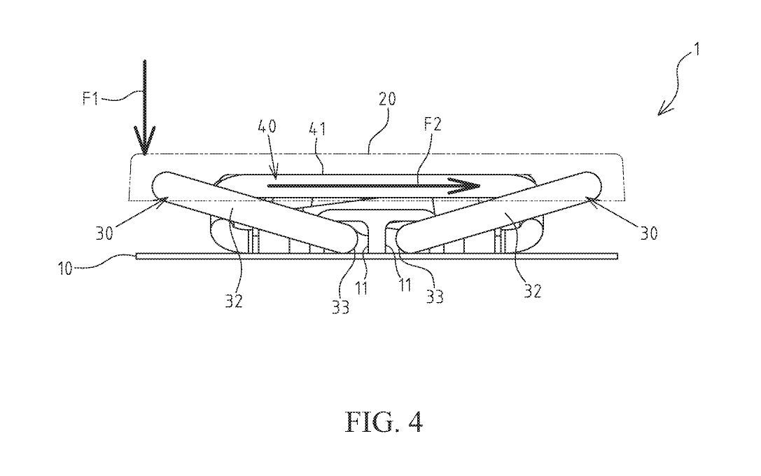

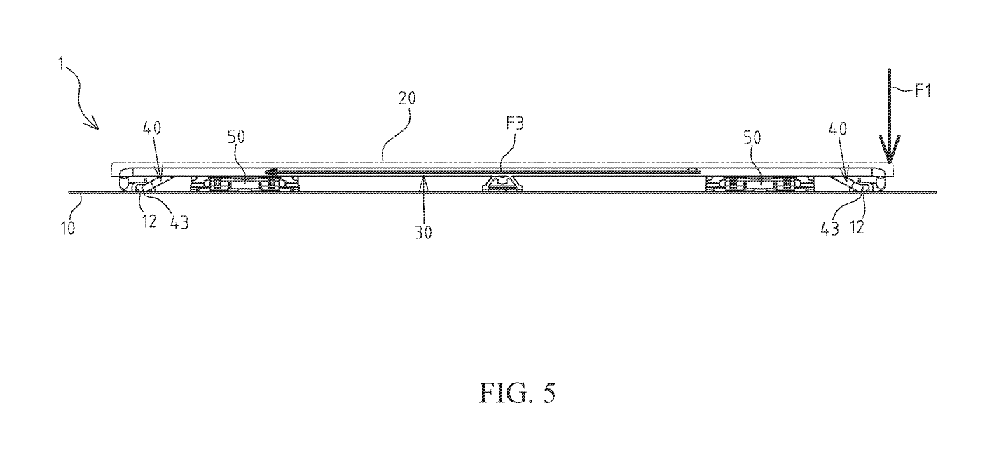

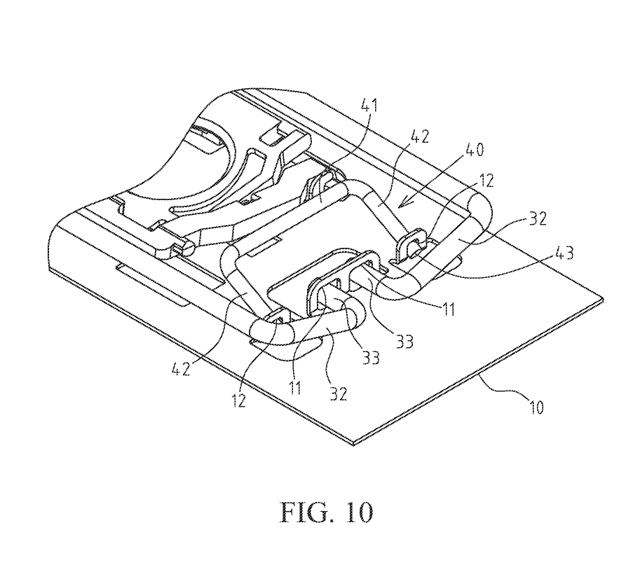

Furthermore, please refer to FIG. 2, FIG. 4 and FIG. 5, in which embodiment the keycap member 20 further includes an inner surface 23 (as shown in FIG. 2). A plurality of pivoting portions 24 is disposed on the inner surface 23, and the first shaft 31 and the second shaft 41 are respectively pivoted with the pivoting portions 24, so that the first shaft 31 and the second shaft 41 are rotatable respect to the pivoting portions 24. The substrate 10 further includes a plurality of first slidable grooves 11 and a plurality of second slidable grooves 12. The first slidable grooves 11 are substantially parallel to the profile lines of the short lateral sides 21, and the second slidable grooves 12 are substantially parallel to the profile lines of the long lateral sides 22. In this embodiment, the first connecting portions 33 of each first balance rod 30 are respectively connected to a first transverse rod of the end portions of each corresponding first lateral rod 32, and the first connecting portions 33 are respectively connected to the first slidable grooves 11. The second connecting portions 43 of each second balance rod 40 are two second transverse rods which respectively connected to the end portions of each corresponding second lateral rod 42, and the second connecting portions 43 are respectively connected to the second slidable groove 12. Upon the first balance rod 30 being forced, each first connecting portion 33 is slidable along the extended direction of each corresponding first slidable groove 11; similarly, upon the second balance rod 40 being forced, each second connecting portion 43 is slidable along the extended direction of each corresponding second slidable groove 12. Alternatively, as shown in FIG. 10, the second connecting portions 43 of each second balance rod 40 are respectively the end portions of each corresponding second lateral rod 42, and the second connecting portions 43 are respectively inserted with the second slidable grooves 12; similarly, the first connecting portions 33 of each first balance rod 30 are respectively the end portions of each corresponding first lateral rod 32 (not shown), embodiments are not limited thereto. Additionally, a first angle is defined between the first lateral rod 32 of the first balance rod 30 and the substrate 10, and a second angle is defined between the second lateral rod 42 of the second balance rod 40 and the substrate 10. Either the first angle or the second angle is not equal to 90 degrees, so that when the first balance rod 30 and the second balance rod 40 are pressed, the first shaft 31 and the second shaft 41 can be rotated, and the first connecting portions 33 and the second connecting portions 43 can be slid.

In some implementation aspects, the key 1 further includes a plurality of cross-type connecting members 50 and a rubber dome 51 disposed between the keycap member 20 and the substrate 10. Each of the cross-type connecting members 50 is respectively connected to the short lateral sides 21 and the substrate 10. The rubber dome 51 is connected to the keycap member 20 and the substrate 10 and disposed at a middle portion of the key 1. Besides, a circuit board (not shown), is further assembled on the substrate 10, so that the rubber dome 51 is moved downward to contact with the circuit board to generate signal upon being pressed.

Based on the above, the keycap member 20 includes the first balance rods 30 assembled on the long lateral sides 22 thereof, and includes the second balance rods 40 assembled on the short lateral sides 21 thereof. Moreover, the extended direction of the first balance rod 30 is parallel to the profile lines of the long lateral sides 22, and the extended direction of the second balance rod 40 is parallel to the profile lines of the short lateral sides 21. Consequently, the keycap member 20 is moved downward uniformly to generate signal upon being pressed, the details of which are described in the following paragraphs.

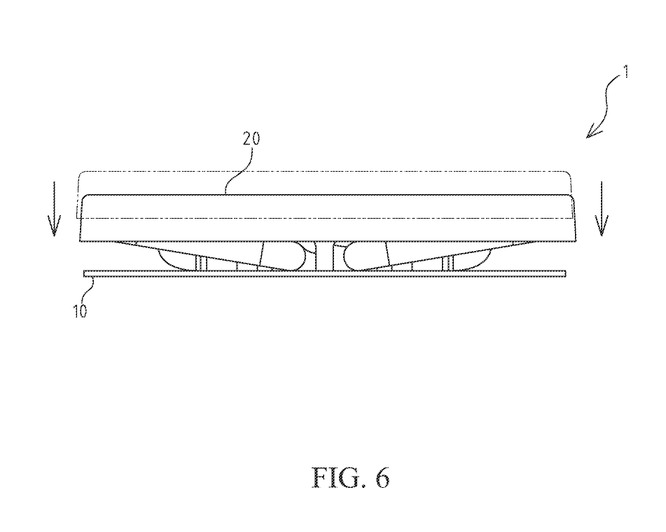

The user cannot always press the center portion of the keycap member 20 accurately upon operating the keyboard; thus, referring to FIG. 4 and FIG. 5, when the user presses the edge or the corner of the keycap member 20 (as indicated by F1, which illustrates the corner of the keycap member 20 is pressed), the force applied is delivered instantly along the extended direction of the short lateral side 21 of the keycap member 20 through the second balance rod 40 (as indicated by F2 in FIG. 4), and along the extended direction of the long lateral side 22 of the keycap member 20 through the first balance rod 30 (as indicated by F3 in FIG. 5), so that even when the user presses the edge or the corner of the keycap member 20, the force applied is delivered to all parts of the keycap member 20. Accordingly, as shown in FIG. 6, the keycap member 20 is moved downward uniformly upon being pressed to avoid the keycap member 20 from being deformed, tilted or shaken, so that the keycap member 20 drives the rubber dome 51 to contact with the circuit board to generate signal, thereby allowing the reduce of thickness of the keyboard; additionally, the user can use the keyboard in a smooth manner during operation.

The configurations of the first balance rod 30 and the second balance rod 40 are optional and described in the following paragraphs.

As shown in FIG. 3, the two ends of each first balance rod 30 are respectively disposed between each corresponding cross-type connecting member 50 and the profile lines of each corresponding short lateral sides 21. That is, the two first connecting portions 33 of each first balance rod 30 is connected to the substrate 10 and disposed between each corresponding cross-type connecting member 50 and the profile lines of each corresponding short lateral sides 21.

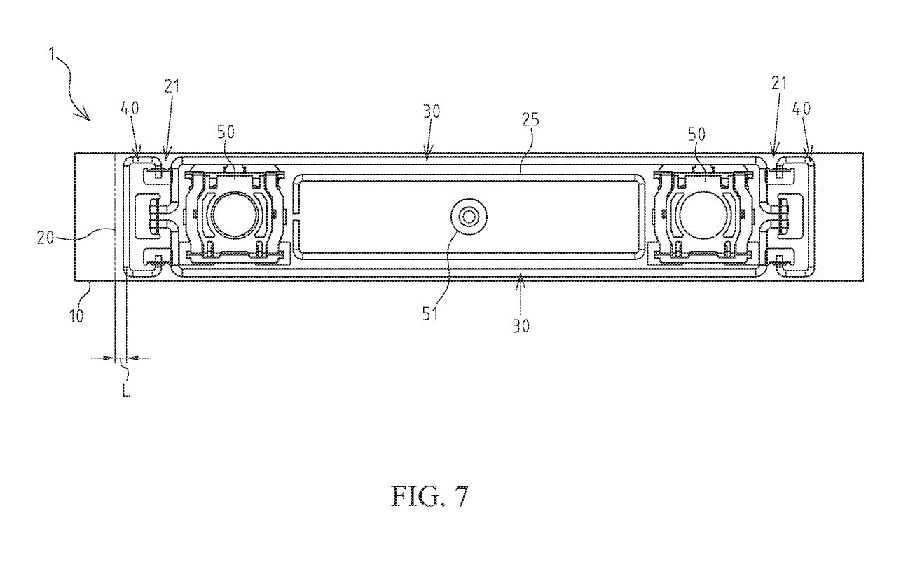

As shown in FIG. 3, similarly, each second balance rod 40 is disposed between each corresponding cross-type connecting member 50 and the profile lines of each corresponding short lateral sides 21, and is disposed between each corresponding cross-type connecting member 50 and the first lateral rod 32 of the end portion of each corresponding first balance rod 30. Alternatively, as shown in FIG. 7, each the second balance rod 40 is optionally disposed between the first lateral rod 32 of the end portion of each corresponding first balance rod 30 and the profile lines of each corresponding short lateral sides 21.

Furthermore, at least one enforcing member 25 is provided to be assembled between the cross-type connecting members 50. The enforcing member 25 is a hard structure corresponding to the shape of the bottom of the keycap member 20, such as a metal rod or a metal plate; as shown in FIG. 3, one enforcing member 25 is disposed between the cross-type connecting members 50. In this embodiment, the enforcing member 25 is a metal rod bent into a rectangle and is provided for enhancing the strength of the keycap member 20 to prevent the keycap member 20 from being deformed or shaken upon being forced.

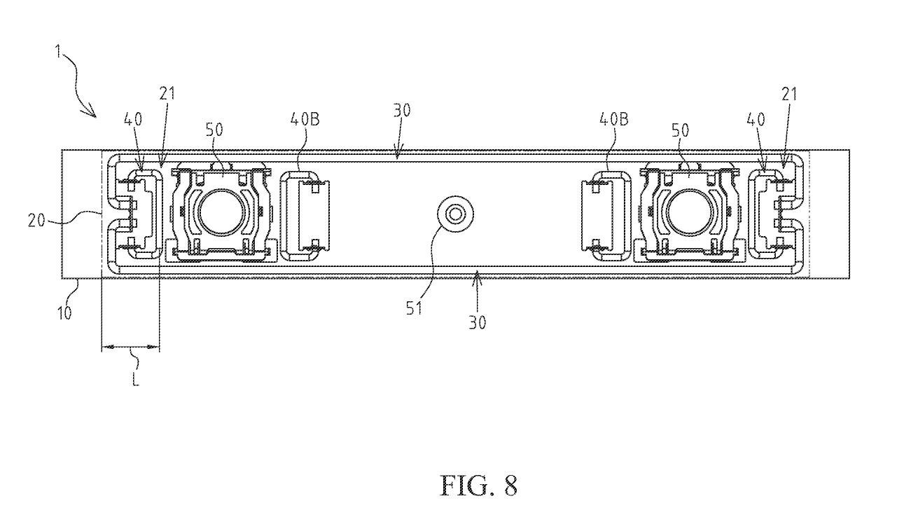

Additionally, as shown in FIG. 8, at least one second balance rod 40B is provided to be assembled between the cross-type connecting members 50, so that the speed for delivering the applied force along the extended direction of the short lateral sides 21 of the keycap member 20 can be faster. As shown in FIG. 8, in which two second balance rods 40B is assembled between the cross-type connecting members 50, and each of the aforementioned second balance rods 40B is adjacent to each corresponding cross-type connecting members 50.

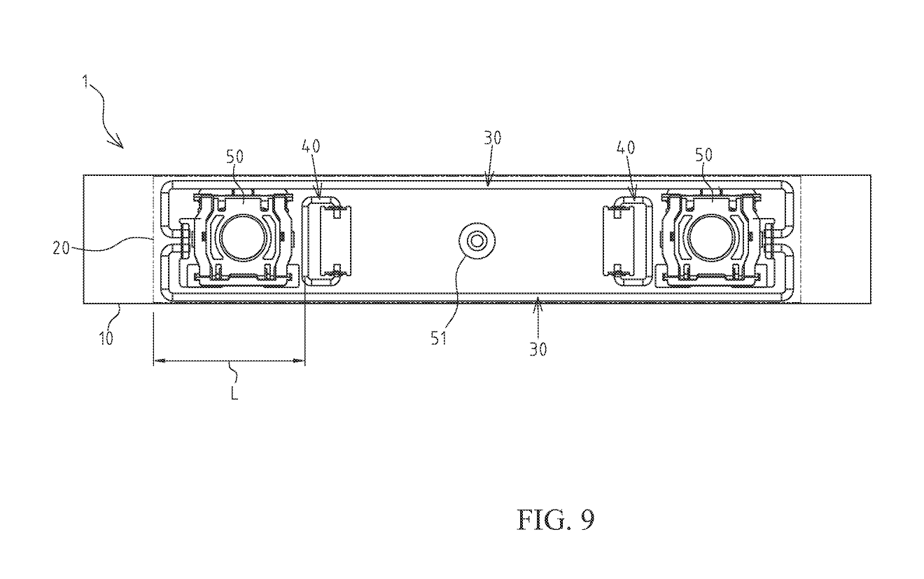

Alternatively, as shown in FIG. 9, in which the two ends of the first balance rod 30 are respectively disposed between each corresponding cross-type connecting member 50 and the profile lines of each corresponding short lateral sides 21, and each second balance rod 40 is disposed between the cross-type connecting members 50 and adjacent to each corresponding cross-type connecting member 50.

Please refer to FIG. 3, FIG. 7, FIG. 8 and FIG. 9, in which a distance (as indicated by L), between the second shaft 41 and the profile line of the short lateral side 21 adjacent to the second shaft 41 is smaller than 15 mm, but embodiments are not limited thereto; in some implementation aspects, the distance is smaller than 10 mm or 5 mm; alternatively, the second shaft 41 is directly assembled to the profile line of the short lateral side 21. The aforementioned distance is determined according to practical demands. For example, if the thickness of the keycap member 20 becomes thinner, the edge of the keycap member 20 is prone to be deformed or tilted upon being pressed, thus, the distance between the second shaft 41 and the profile lines of the short lateral sides 21 must be small enough. Based on this, the structure of the key 1 of the disclosure is benefit for developing the keyboard manufacturing art in a thin and light manner.

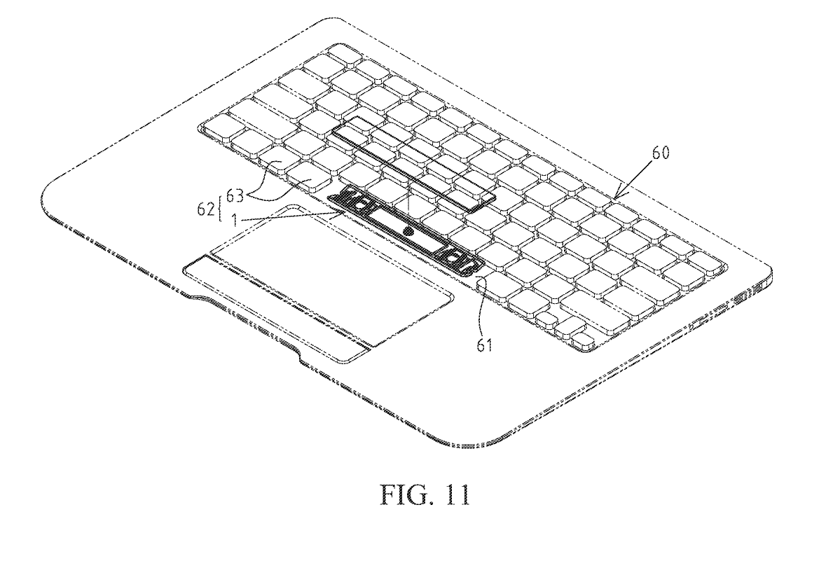

As shown in FIG. 11, the disclosure further provides a keyboard 60. The keyboard 60 includes a substrate 61 and a key assembly 62. The key assembly 62 includes a plurality of normal keys 63 and at least one of aforementioned key 1. The normal keys 63 and the key 1 are respectively movably disposed on the substrate 61. In this embodiment, the key 1 is the Space button of the keyboard 60, but embodiments are not limited thereto. In some implementation aspects, the key 1 can be any one of the elongated shape buttons on the keyboard 60, such as Tab button, Cap Lock button, Shift button, Ctrl button, Alt button, Enter button or Backspace button; while the normal keys 63 can be the buttons with smaller area, such as alphabet keys (A, B, C, D . . . ), number keys (1, 2, 3, 4 . . . ), or other functional keys. Additionally, in some implementation aspects the first balance rod 30 and the second balance rod 40 are provided to assemble with the normal keys 63, but embodiments are not limited thereto.

Accordingly, the keycap member includes the first balance rods assembled on the long lateral sides thereof, and includes the second balance rods assembled on the short lateral sides thereof. Furthermore, the extended direction of the first balance rod is parallel to the profile lines of the long lateral sides, and the extended direction of the second balance rod is parallel to the profile lines of the short lateral sides. Consequently, even when the edge or the corner of the keycap member is pressed, the force applied is delivered simultaneously along the extended directions of the long lateral side and short lateral side of the keycap member, to all parts of the keycap member through the first balance rod and the second balance rod, so that the keycap member can move downward uniformly to generate signal. Based on this, the structure of the key of the disclosure is useful for developing thin and light keyboards.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A key, comprising:
a substrate;
a keycap member, movably disposed on the substrate, the keycap member comprising two short lateral sides and two long lateral sides;
at least a first balance rod, disposed between the keycap member and the substrate, an extended direction of the first balance rod being substantially parallel to profile lines of the long lateral sides, and the first balance rod being connected to one of the two long lateral sides and the substrate; and
a plurality of second balance rods, disposed between the keycap member and the substrate, extended directions of the second balance rods being substantially parallel to profile lines of the short lateral sides, each of the second balance rods being connected to each corresponding of short lateral sides and the substrate.

2. The key according claim 1, wherein each of the second balance rods comprises a second shaft, two second lateral rods and two second connecting portions, the second lateral rods are respectively connected to two ends of the second shaft, and each of the second connecting portions is respectively disposed at end portions of the second lateral rods, the second shaft is connected to the short lateral sides, and the second connecting portions are connected to the substrate.

3. The key according to claim 2, wherein the first balance rod comprises a first shaft, two first lateral rods and two first connecting portions, the first lateral rods are respectively connected to two ends of the first shaft, and each of the first connecting portions is respectively disposed at end portions of the first lateral rods, the first shaft is connected to the long lateral sides, and the first connecting portions are connected to the substrate.

4. The key according to claim 1, further comprising a plurality of cross-type connecting members and a rubber dome disposed between the keycap member and the substrate, and each of the cross-type connecting members is respectively connected to the short lateral sides and the substrate, the rubber dome is connected to the keycap member and the substrate and disposed at a middle portion of the key.

5. The key according to claim 4, wherein two ends of the first balance rod are respectively disposed between the cross-type member and the profile lines of the short lateral sides.

6. The key according to claim 5, wherein each of the second balance rods is respectively disposed between the cross-type member and the profile lines of the short lateral sides.

7. The key according to claim 6, wherein each of the second balance rods is respectively disposed between the cross-type member and end portions of the first balance rod.

8. The key according to claim 6, wherein each of the second balance rods is respectively disposed between end portions of the first balance rod and the profile lines of the short lateral sides.

9. The key according to claim 6, further comprising at least one second balance rod between the cross-type connecting members.

10. The key according to claim 3, wherein the keycap member further comprises an inner surface, a plurality of pivoting portions is disposed on the inner surface, the first shaft and the second shaft are respectively pivoted to the pivoting portions.

11. The key according to claim 10, wherein the substrate further comprises a plurality of first slidable grooves and a plurality of second slidable grooves, the first connecting portions are slidably connected to the first slidable grooves, the second connecting portions are slidably connected to the second slidable grooves.

12. The key according to claim 11, wherein each of the first connecting portions is a first transverse rod respectively connected to the end portions of the first lateral rod, each of the second connecting portions is respectively connected to a second transverse rod of the end portions of the second lateral rod.

13. The key according to claim 11, wherein the first connecting portions are respectively the end portions of the first lateral rods, the second connecting portions are respectively the end portions of the second lateral rods.

14. The key according to claim 2, wherein a distance between the second shaft and the profile line of the short lateral side adjacent to the second shaft is smaller than 15 mm.

15. The key according to claim 2, wherein a distance between the second shaft and the profile line of the short lateral side adjacent to the second shaft is smaller than 10 mm.

16. The key according to claim 1, further comprising another first balance rod, the two first balance rods being disposed at a bottom of the keycap member symmetrically.

17. The key according to claim 1, wherein the keycap member further comprises at least one enforcing member at the bottom thereof.

18. The key according to claim 17, wherein the enforcing member is a hard rod or a hard plate connected to the bottom of the keycap member.
